(19) United States
(12) Patent Application Publication
(10) Pub. No.: US 2025/0387945 A1
(43) Pub. Date: Dec. 25, 2025

(54) EXTENSION ASSEMBLY FOR A 3D CONCRETE PRINTING MACHINE AND A 3D PRINTING ROBOT

(71) Applicant: Weiguo Xu, Beijing (CN)

(72) Inventors: Ziyou Xu, Beijing (CN); Weiguo Xu, Beijing (CN); Kai Xing, Beijing (CN)

(21) Appl. No.: 19/308,337

(22) Filed: Aug. 25, 2025

(30) Foreign Application Priority Data
Dec. 30, 2024 (CN) 202423269786.5

(51) Int. Cl. B28B 1/00; B33Y 30/00

(52) U.S. Cl. CPC B28B 1/001; B33Y 30/00

(57) ABSTRACT

This invention discloses an extension assembly for a 3D concrete printing machine and a 3D printing robot, in the field of 3D printing in construction. The assembly comprises an extension frame and a printing cylinder connecting bracket. The extension frame includes a mounting portion at one end, and a printing cylinder mounting portion at the other. The extension frame includes at least two layers of mounting beams. The printing cylinder connecting bracket connects to the second end, and includes at least two layers of positioning cantilever plates, whose mounting positions on the beams can be adjusted to vary the bracket's vertical position. The 3D printing robot incorporates the extension assembly, enabling expansion of the printable area. Mounting the printing cylinder on the extension frame allows adjustment of the robotic arm's maximum working height to accommodate elevated positions of the arm body. The assembly features low cost, and high adjustment efficiency.

### TECHNICAL FIELD

The disclosure relates to the field of 3D printing technology, and more particularly to an extension assembly for a 3D concrete printer and a 3D printing robot.

### BACKGROUND ART

3D printing technology is a type of additive manufacturing technology that forms by continuous physical stacking. Due to its advantages of being fast, intuitive, and low-cost, 3D printing using materials such as PLA, resin, and metal powders has been widely applied in fields including industrial design, medical, aerospace, driving innovation across industries. Concrete 3D printing, as an emerging digital construction technology in the architectural field, commonly employs robotic arms as printing tools. The robotic arms are typically six-axis and capable of building structures at arbitrary angle. However, due to limitations in their mobility and height, the printing range is constrained. To expand the printing capacity, additional mechanisms are often incorporated to enlarge the horizontal printing area and extend the vertical printing height.

Existing mechanisms for expanding the printing range of robotic arms mainly include mobile platforms such as tracks, trusses, and walking mechanisms (crawler-type or wheeled vehicles). These platforms allow the robotic arm mounted on the platform to move over a large horizontal area or be elevated within a limited vertical range. However, when it is required to expand the printing plane in a small range, the existing mechanisms are typically bulky and heavy, resulting in high transportation costs and manufacturing expenses. The movement requires re-laying of tracks or trusses, or activating mobile vehicles, followed by repositioning and recalibration after movement, leading to low efficiency. When the printing height needs to be increased, current solutions usually lift the entire robotic arm, which consumes a large amount of energy and offers limited elevation. In addition, when the robotic arm is lifted by platforms such as bases or vehicles, its maximum working plane height becomes significantly higher, while its effective printing range near the ground is reduced.

Therefore, how to provide an expansion assembly for a 3D concrete printer that can quickly and efficiently achieve a small-range expansion of the robotic arm's printing area is a technical problem in this field urgently need to be solved.

### SUMMARY

In view of the above, the present disclosure provides an extension assembly for a 3D concrete printing machine and a 3D printing robot, which aims to solve the above technical problems.

In order to achieve the above purpose, the present disclosure adopts the following technical scheme.

An extension assembly for a 3D concrete printing machine specifically includes the following steps as follows.

An extension frame, has a first end configured as an extension frame mounting portion, and a second end configured as a printing cylinder mounting portion. The extension frame comprises at least two layers of mounting beams.

A printing cylinder connecting bracket, is connected to the printing cylinder mounting portion, and comprises at least two layers of positioning cantilever plates connected to the mounting beams. The vertical position of the printing cylinder connecting bracket relative to the extension frame is adjustable by varying the mounting positions of the positioning cantilever plates on the mounting beams.

By adopting the above technical solution, the present invention enables expansion of the printing area through the extension frame. The printing cylinder mounted on the extension frame allows adjustment of the maximum working height of the robotic arm to accommodate situations where the arm is elevated. The extension frame and the printing cylinder are available in various types and connection methods, allowing flexible combinations according to different printing requirements, thereby increasing the overall printing range. Compared to existing mobile platform mechanisms, the disclosed extension assembly offers lower transportation costs, higher adjustment efficiency, and reduced manufacturing costs.

Preferably, in the above-described extension assembly for a 3D concrete printing machine, the extension frame is a rectangular elongated frame structure or an obliquely elongated frame structure with end portions.

Preferably, in the above-described extension assembly for a 3D concrete printing machine, a U-shaped notch is formed at the printing cylinder mounting portion of the extension frame.

Preferably, in the above-described extension assembly for a 3D concrete printing machine, the U-shaped notch is provided with a U-shaped securing plate fixed thereto.

Preferably, in the above-described extension assembly for a 3D concrete printing machine, the printing cylinder connecting bracket is connected to the mounting beams via a vertical extension cylinder or a height-increasing block.

Preferably, in the above-described extension assembly for a 3D concrete printing machine, a guide rail is provided on the mounting beam, or the mounting beam is made of aluminum profile.

Preferably, in the above-described extension assembly for a 3D concrete printing machine, a slider is slidably connected to the guide rail, and the slider is connected to the positioning cantilever plate. Alternatively, the positioning cantilever plate is provided with a bolt fastener slidably connected to a groove of the aluminum profile.

Preferably, in the above-described extension assembly for a 3D concrete printing machine, a printing cylinder is connected to the bottom of the printing cylinder connecting bracket.

Preferably, in the above-described extension assembly for a 3D concrete printing machine, a modular extension cylinder is connected to the discharge port of the printing cylinder.

The present invention further provides a 3D printing robot, comprising the extension assembly of the 3D concrete printing machine.

According to the above technical solution, and in comparison with the prior art, the present invention discloses an extension assembly for a 3D concrete printing machine and a 3D printing robot that offer the following advantageous effects:

(1) The extension frame expands the printing plane and allows for adaptation to different printing scale requirements by adjusting its length.

(2) The upward-inclined extension frame ensures that the print nozzle remains vertically downward when printing at higher positions, thereby extending the printable height range.

(3) The rail-type extension frame enables the robotic arm to print near the end of its reach even with the extension installed, addressing special printing needs in specific scenarios.

(4) The printing cylinder is movable along the extension frame, allowing its position relative to the robotic arm to be adjusted according to different printing scale requirements.

(5) The printing cylinder is optionally fitted with vertical extension cylinder and modular extension cylinder to expand the printable height range, allowing effective printing at both low and elevated positions.

(6) Nozzles of different diameters may be interchangeably mounted at the lower end of the printing barrel, allowing adaptation to changes in output scale and printed bead width for fine-scale applications.

(7) Locking points are employed to fasten the printing cylinder to the extension frame, providing a secure and stable connection.

### DESCRIPTION OF THE ACCOMPANYING DRAWINGS

In order to more clearly illustrate the embodiments of the present disclosure or the technical solutions in the prior art, the drawings that are required to be used in the embodiments or the description of the prior art will be briefly described below, and it is obvious that the drawings in the following description are only embodiments of the present disclosure, and that other drawings can be obtained according to the provided drawings without inventive effort for a person skilled in the art.

FIG. 1 is a schematic structural diagram of the extension assembly for a 3D concrete printing machine according to the present invention;

FIG. 2 is a schematic structural diagram of the extension assembly for a 3D concrete printing machine according to the present invention with an added modular extension cylinder;

FIG. 3 is a schematic structural diagram of a first form of Embodiment 1 according to the present invention;

FIG. 4 is a schematic structural diagram of a second form of Embodiment 1 according to the present invention;

FIG. 5 is a schematic structural diagram of Embodiment 2 according to the present invention.

FIG. 6 is a schematic structural diagram of Embodiment 3 according to the present invention.

FIG. 7 is a schematic structural diagram of a first form of Embodiment 4 according to the present invention.

FIG. 8 is a schematic structural diagram of a second form of Embodiment 4 according to the present invention.

FIG. 9 is a schematic structural diagram of a first form of Embodiment 5 according to the present invention.

FIG. 10 is a schematic structural diagram of a second form of Embodiment 5 according to the present invention.

FIG. 11 is a schematic structural diagram of a first form of Embodiment 6 according to the present invention.

FIG. 12 is a schematic structural diagram of a second form of Embodiment 6 according to the present invention.

FIG. 13 is a schematic diagram showing the printing range achieved using merely a conventional print head, as provided by the present invention.

FIG. 14 is a schematic diagram showing the printing range achieved after expanding the printing plane using the extension frame, as provided by the present invention.

FIG. 15 is a schematic diagram showing the printing range achieved after simultaneously expanding the printing plane and height using the extension frame and the vertical extension cylinder, as provided by the present invention.

FIG. 16 is a schematic diagram showing the effect of the rail-type extension frame in expanding the printing plane, as provided by the present invention.

### THEREINTO

1—Extension Frame
11—Mounting portion of the extension frame, 12—Mounting portion of the printing cylinder, 121—U-shaped notch, 13—Mounting beams, 131—guide rail, 132—slider, 14—U-shaped securing plate
2—printing cylinder connecting bracket
21—positioning cantilever plate, 22—vertical extension cylinder, 23—height-increasing block
3—printing cylinder
4—modular extension cylinder

### DETAILED DESCRIPTION OF THE EMBODIMENTS

The following description of the embodiments of the present disclosure will be made clearly and completely with reference to the accompanying drawings, in which it is apparent that the embodiments described are only some embodiments of the present disclosure, but not all embodiments. All other embodiments, which can be made by those skilled in the art based on the embodiments of the disclosure without making any inventive effort, are intended to be within the scope of the disclosure.

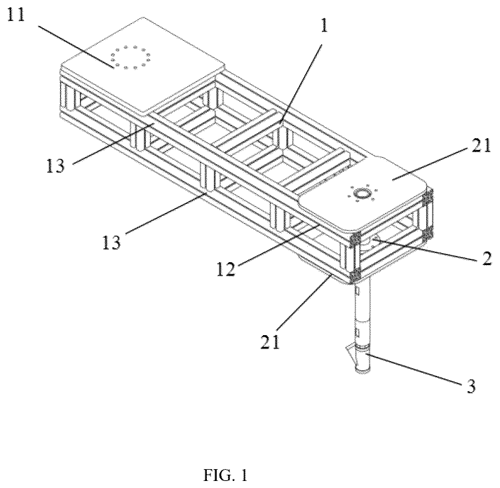

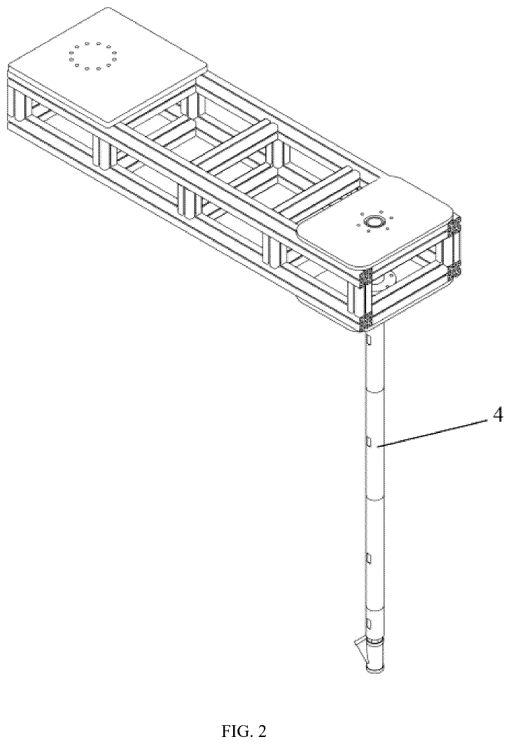

Referring to FIG. 1 to FIG. 2, an embodiment of the present invention discloses an extension assembly for a 3D concrete printing machine, which comprises:
The extension frame 1, has a first end configured as an extension frame mounting portion 11, and a second end configured as a printing cylinder mounting portion 12. The extension frame 1 comprises at least two layers of mounting beams 13;
The printing cylinder connecting bracket 2 is connected to the printing cylinder mounting portion 12, and comprises at least two layers of positioning cantilever plates 21 connected to the mounting beams 13. The vertical position of the printing cylinder connecting bracket 2 relative to the extension frame 1 is adjustable by varying the mounting positions of the positioning cantilever plates 21 on the mounting beams 13;
The extension frame 1 is flange-mounted to the end of the robotic arm via the extension frame mounting portion 11;
The printing cylinder 3 is connected to the end of the printing cylinder connecting bracket 2;
The extension frame 1 expands the original printing range of the robotic arm and reduces the risk of self-collision during operation.

### Embodiment 1

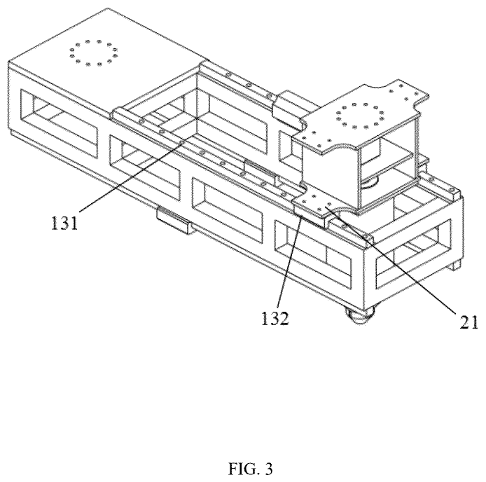

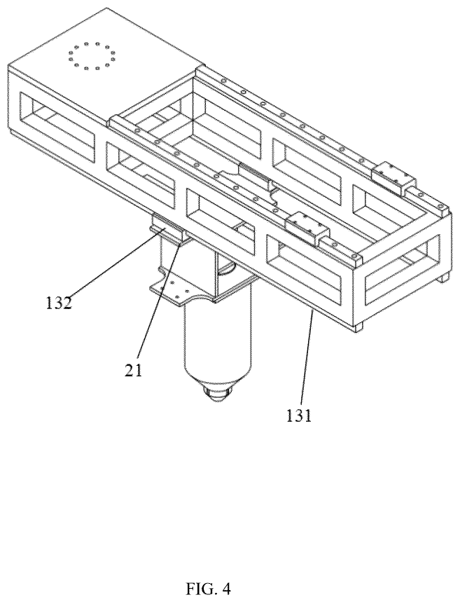

Referring to FIG. 3 and FIG. 4, in the present embodiment, the extension frame 1 is a rectangular elongated frame structure.

To clearly illustrate the structure, in the present embodiment and in the embodiments described below, the extension frame 1 comprises two layers of mounting beams 13.
To further optimize the above technical solution, a slider 132 is slidably connected to the guide rail 131, and the slider 132 is connected to the positioning cantilever plate 21. To accommodate printing objects of varying scales, the printing cylinder 3 may be fixed at any position along the extension frame 1 by means of a slider 132 mounted on the guide rail 131.
In the present embodiment, the printing cylinder connecting bracket 2 comprises at least two layers of positioning cantilever plates 21. FIG. 3 is a schematic view of the connection between the lower positioning cantilever plate 21 and the slider 132 on the guide rail 131 of the upper mounting beam 13. FIG. 4 is a schematic view of the connection between the upper positioning cantilever plate 21 and the slider 132 on the guide rail 131 of the lower mounting beam 13.

### Embodiment 2

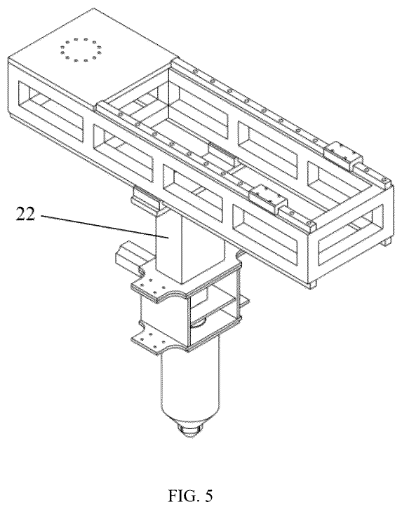

This embodiment provides a further refinement of the Embodiment 1. Referring to FIG. 5, the printing cylinder connecting bracket 2 is connected to the mounting beams 13 via a vertical extension cylinder 22. FIG. 5 is a schematic view of the connection in which the upper positioning cantilever plate 21 is connected to the slider 132 on the guide rail 131 of the lower mounting beam 13 via a vertical extension cylinder 22.

### Embodiment 3

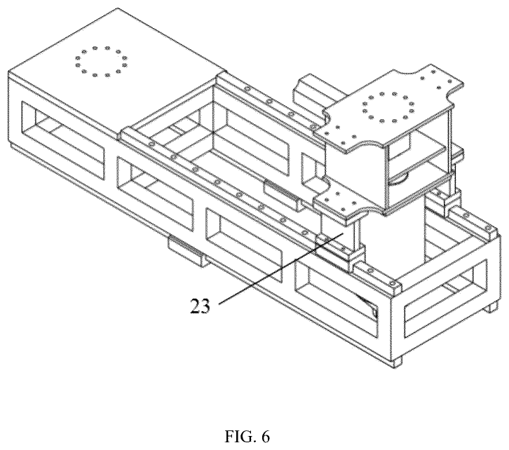

This embodiment provides a further refinement of the Embodiment 1, and also serves as an alternative or parallel solution to Embodiment 2. The printing cylinder connecting bracket 2 is connected to the mounting beams 13 via a height-increasing block 23. FIG. 6 is a schematic view of the connection in which the lower positioning cantilever plate 21 is connected to the slider 132 on the guide rail 131 of the lower mounting beam 13 via a height-increasing block 23.

### Embodiment 4

The difference between this embodiment and embodiment 1 is that: The mounting beam 13 is made of aluminum profile, and the positioning cantilever plate 21 is provided with a bolt fastener slidably connected to a groove of the aluminum profile.

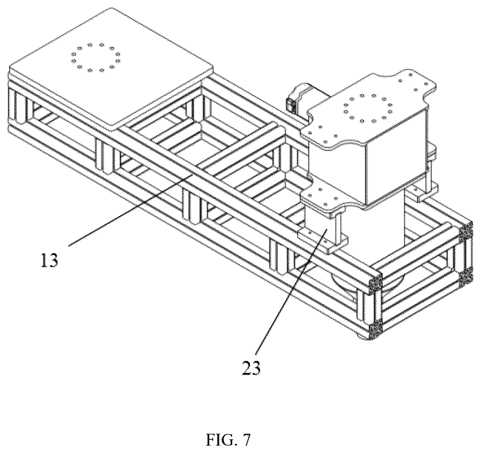

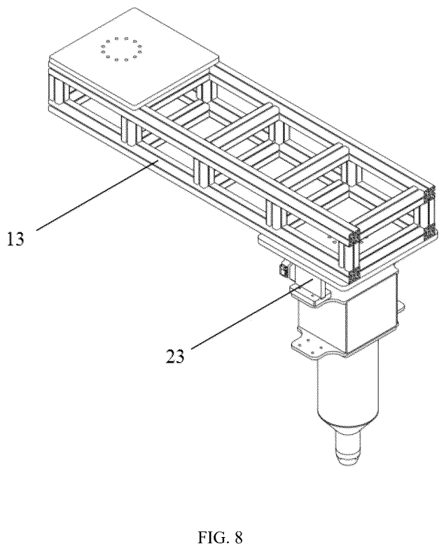

In the present embodiment, groove design of the aluminum profile inherently provides a sliding channel for mating connection.
In the present embodiment, the structure of a vertical extension cylinder 22 or a height-increasing block 23 may be added in the manner described in Embodiment 2 or Embodiment 3.
FIG. 7 is a schematic view of the connection in which the lower positioning cantilever plate 21 is connected to the height-increasing block 23, and further secured to the upper aluminum profile groove via bolt fasteners.
FIG. 8 is a schematic view of the connection in which the upper positioning cantilever plate 21 is connected to the height-increasing block 23, and further secured to the lower aluminum profile groove via bolt fasteners.

### Embodiment 5

In the present embodiment, a U-shaped notch 121 is formed at the printing cylinder mounting portion 12 of the extension frame 1.

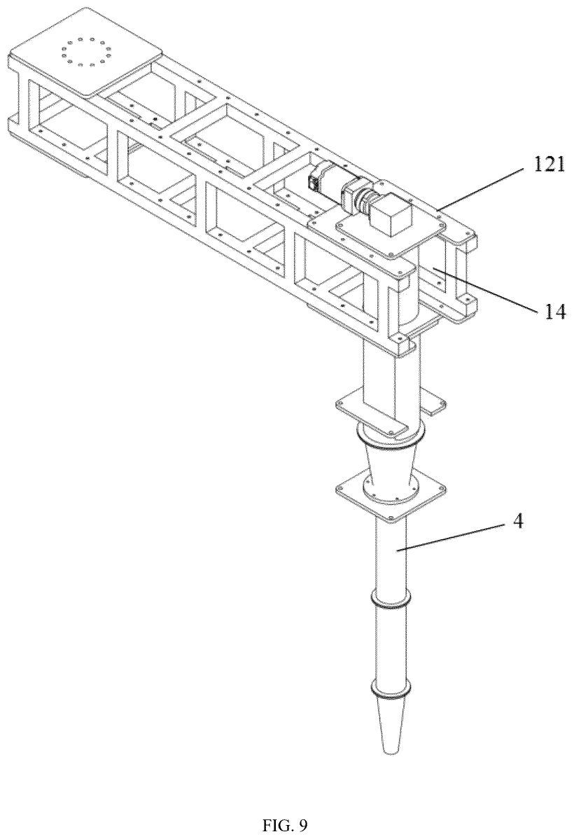

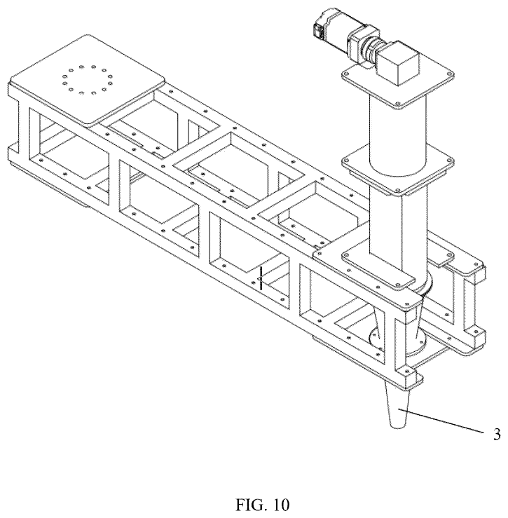

To further optimize the above technical solution, the U-shaped notch 121 is provided with a U-shaped securing plate 14 fixed thereto.
In the present embodiment, the printing cylinder connecting bracket 2 comprises multiple positioning cantilever plates 21. Each of the two adjacent positioning cantilever plates 21 is connected to a corresponding one of the upper and lower mounting beams 13, there by improving the structural stability.
FIG. 9 and FIG. 10 illustrate schematic views of two different vertical height configurations.
To further optimize the above technical solution, a modular extension cylinder 4 is connected to the discharge port of the printing cylinder 3, according to FIG. 9.

### Embodiment 6

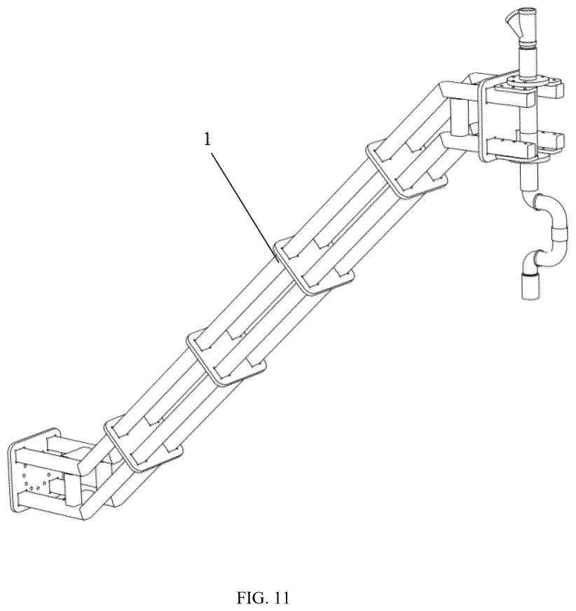

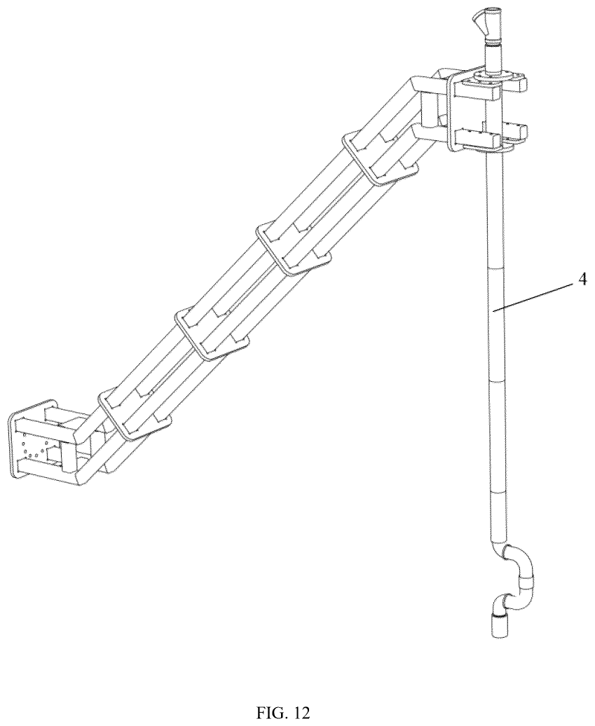

Referring to FIG. 11 and FIG. 12, in the present embodiment, the extension frame 1 is an obliquely elongated frame structure.

In the present embodiment, the printing cylinder connecting bracket 2 comprises two layers of positioning cantilever plates 21. The vertical position is adjustable by selectively adding or removing modular extension cylinder 4.
In concrete additive manufacturing, it is essential for the print nozzle to remain substantially vertically downward. The upward-inclined extension frame disclosed in this embodiment effectively addresses the issue of maintaining nozzle orientation when the robotic arm is lifted. Moreover, by adjusting the length of the extension frame, the lifting height can be modified, thereby allowing printing at higher positions.

In the above embodiments, all connection positions are fastened and positioned using bolts.

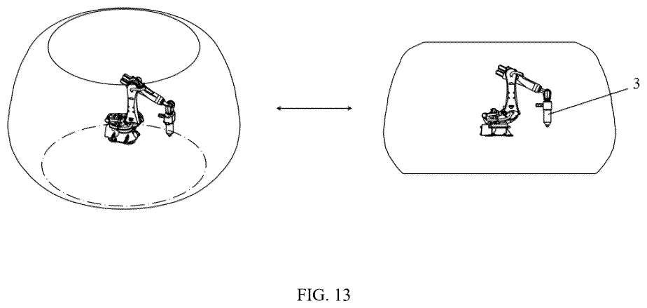

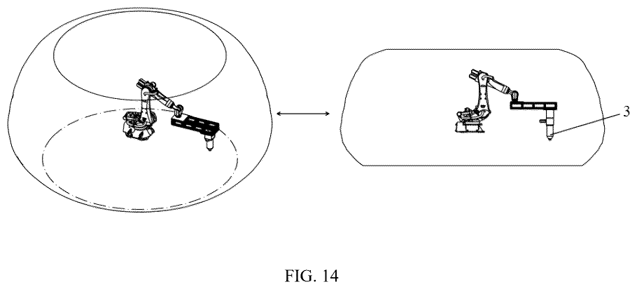

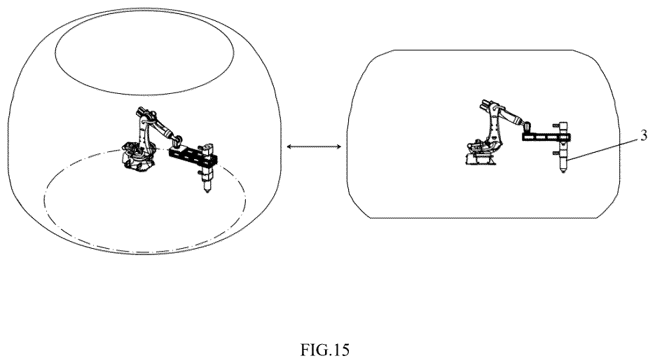

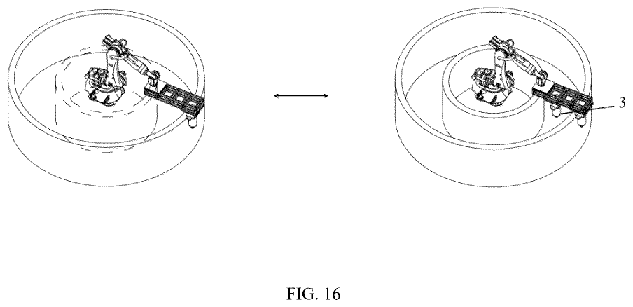

Referring to FIG. 13 and FIG. 16: the figures illustrate the effect of the extension assembly in expanding the printing range in the present invention. FIG. 13 illustrates the printing range when using only a conventional printing head. FIG. 14 illustrates the printing range after expanding the printing plane using the extension frame. FIG. 15 illustrates the printing range after simultaneously expanding the printing plane and height using the extension frame and the vertical extension cylinder.

FIG. 16 illustrates the effect of the rail-type extension frame in expanding the printing plane in the present invention. The left figure shows that with other types of extension frames, the printing range is located outside the end of the robotic arm, making it impossible to print the wall section in the end region of the robotic arm, as indicated by the dashed lines. The right figure shows that after using the rail-type extension frame, the wall section in the end region of the robotic arm can also be printed, which is achieved by moving the print cylinder along the guide rail.

In the specification, each embodiment is described in a progressive manner, and each embodiment is mainly described in a different point from other embodiments, and identical and similar parts between the embodiments are all enough to refer to each other. For the device disclosed in the embodiment, since it corresponds to the method disclosed in the embodiment, the description is relatively simple, and the relevant points refer to the description of the method section.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. An extension assembly for 3D concrete printing machine, it has the following characteristics:
The extension frame (1), has a first end configured as an extension frame mounting portion (11), and a second end configured as a printing cylinder mounting portion (12). The extension frame (1) comprises at least two layers of mounting beams (13).
The printing cylinder connecting bracket (2) is connected to the printing cylinder mounting portion (12), and comprises at least two layers of positioning cantilever plates (21) connected to the mounting beams (13). The vertical position of the printing cylinder connecting bracket (2) relative to the extension frame (1) is adjustable by varying the mounting positions of the positioning cantilever plates (21) on the mounting beams (13).

2. An extension assembly of a 3D concrete printing machine according to claim 1, wherein the extension frame (1) is a rectangular elongated frame structure or an obliquely elongated frame structure with end portions.

3. An extension assembly of a 3D concrete printing machine according to claim 1, wherein a U-shaped notch (121) is formed at the printing cylinder mounting portion (12) of the extension frame (1).

4. An extension assembly of a 3D concrete printing machine according to claim 3, wherein the U-shaped notch (121) is provided with a U-shaped securing plate (14) fixed thereto.

5. An extension assembly of a 3D concrete printing machine according to claim 1, wherein the printing cylinder connecting bracket (2) is connected to the mounting beams (13) via a vertical extension cylinder (22) or a height-increasing block (23).

6. An extension assembly of a 3D concrete printing machine according to claim 1, wherein a guide rail (131) is provided on the mounting beam (13), or the mounting beam (13) is made of aluminum profile.

7. An extension assembly of a 3D concrete printing machine according to claim 6, wherein a slider (132) is slidably connected to the guide rail (131), and the slider (132) is connected to the positioning cantilever plate (21). Alternatively, the positioning cantilever plate (21) is provided with a bolt fastener slidably connected to a groove of the aluminum profile.

8. An extension assembly of a 3D concrete printing machine according to claim 1, wherein a printing cylinder (3) is connected to the bottom of the printing cylinder connecting bracket (2).

9. An extension assembly of a 3D concrete printing machine according to claim 8, wherein a modular extension cylinder (4) is connected to the discharge port of the printing cylinder (3).

10. A 3D printing robot, characterized in that it comprises the extension assembly of the 3D concrete printing machine according to claim 1.

11. A 3D printing robot, characterized in that it comprises the extension assembly of the 3D concrete printing machine according to claim 2.

12. A 3D printing robot, characterized in that it comprises the extension assembly of the 3D concrete printing machine according to claim 3.

13. A 3D printing robot, characterized in that it comprises the extension assembly of the 3D concrete printing machine according to claim 4.

14. A 3D printing robot, characterized in that it comprises the extension assembly of the 3D concrete printing machine according to claim 5.

15. A 3D printing robot, characterized in that it comprises the extension assembly of the 3D concrete printing machine according to claim 6.

16. A 3D printing robot, characterized in that it comprises the extension assembly of the 3D concrete printing machine according to claim 7.

17. A 3D printing robot, characterized in that it comprises the extension assembly of the 3D concrete printing machine according to claim 8.

18. A 3D printing robot, characterized in that it comprises the extension assembly of the 3D concrete printing machine according to claim 9.
